(19) United States
(12) Patent Application Publication
(10) Pub. No.: US 2011/0261580 A1
(43) Pub. Date: Oct. 27, 2011

(54) OPTICAL FIBER COUPLER, METHOD OF MANUFACTURING THE SAME, AND ACTIVE OPTICAL MODULE

(75) Inventors: Hong-Seok SEO, Daejeon (KR); Joon Tae AHN, Daejeon (KR); Bong Je PARK, Daejeon (KR)

(73) Assignee: ELECTRONICS AND TELECOMMUNICATIONS RESEARCH INSTITUTE, Daejeon (KR)

(21) Appl. No.: 12/946,605

(22) Filed: Nov. 15, 2010

(30) Foreign Application Priority Data
Apr. 23, 2010 (KR) 10-2010-0037904

(51) Int. Cl. H01S 3/00; G02B 6/25; G02B 6/28

(52) U.S. Cl. 362/553; 385/24; 216/24

(57) ABSTRACT

Provided are an optical fiber coupler, a method of manufacturing the same, and an active optical module. The optical fiber coupler comprises a first core, a first optical fiber, and a plurality of second optical fibers. The first optical fiber comprises a first cladding surrounding a first core. The plurality of second optical fibers have a tapering region of a cylindrical shape and surround the first cladding of the first optical fiber. Here, the first core has the same diameter within the tapering region.

### CROSS-REFERENCE TO RELATED APPLICATIONS

This U.S. non-provisional patent application claims priority under 35 U.S.C. §119 of Korean Patent Application No. 10-2010-0037904, filed on Apr. 23, 2010, the entire contents of which are hereby incorporated by reference.

### BACKGROUND OF THE INVENTION

The present invention disclosed herein relates to an optical fiber coupler, a method of manufacturing the same, and an active optical module, and more particularly, to an optical fiber coupler, a method of manufacturing the same, and an active optical module, in which a multi mode fiber is connected to a double cladding optical fiber.

Laser light may be oscillated by various kinds of lasers. Examples of lasers may comprise semiconductor-based layers, crystal-based solid lasers, and optical fiber lasers. The optical fiber lasers may comprise optical fibers having a double cladding structure. The optical fiber lasers may generate laser light by supplying pump light to a core to which active medium is added. The optical fiber lasers may output high-power laser light by efficiently supplying the pump light to the core of an optical fiber through an optical fiber coupler.

### SUMMARY OF THE INVENTION

The present invention provides an optical fiber coupler, a method of manufacturing the same, and an active optical module, which can increase optical efficiency.

The present invention also provides an optical fiber coupler, a method of manufacturing the same, and an active optical module, which can increase or maximize the lifespan of a pump light source.

The present invention also provides an optical fiber coupler, a method of manufacturing the same, and an active optical module, which can reduce optical loss due to a diameter difference between cores, generated in coupling of a double cladding optical fiber.

Embodiments of the present invention provide optical fiber couplers comprising: a first core; a first optical fiber comprising a first cladding surrounding a first core; and a plurality of second optical fibers having a tapering region of a cylindrical shape and surrounding the first cladding of the first optical fiber, wherein the first core has the same diameter within the tapering region.

In some embodiments, the first optical fiber may further comprise a second cladding surrounding the first cladding.

In other embodiments, the second optical fibers may comprise a multi mode fiber.

In other embodiments of the present invention, methods of fabricating an optical fiber coupler comprise: fixing at least one of second optical fibers around a first optical fiber; fusing the second optical fibers to the first optical fiber; and etching the second optical fibers conically.

In some embodiments, the optical fiber coupler may further comprise coating the first optical fiber exposed to the second optical fibers with a protection layer prior to the etching of the second optical fibers.

In other embodiments, the etching of the second optical fibers may comprise at least one of a wet etching and a laser etching.

In still other embodiments, the wet etching may comprise etching the second optical fibers using at least one of buffered etching solution and fluoric acid.

In even other embodiments, the buffered etching solution may comprise ammonium fluoride and fluoric acid.

In yet other embodiments, the second optical fibers may be etched by a laser.

In further embodiments, the methods may further comprise performing a surface treatment after the etching of the second optical fibers.

In still further embodiments, the surface treatment may comprise melting the second fibers using a torch or a laser.

In even further embodiments, the methods may further comprise packaging the first optical fiber and the second optical fibers.

In still other embodiments of the present invention, active optical modules comprise: a pump light source; an optical fiber coupler comprising a first optical fiber comprising a first core and a first cladding surrounding the first core, and a plurality of second optical fibers having a tapering region of a cylindrical shape and surrounding the first cladding of the first optical fiber; a first optical device disposed at one end of the first optical fiber; and a second optical device disposed at the other end of the first optical fiber opposite to the first optical device, the second optical device outputting laser light generated in the first optical fiber, wherein the first core of the optical fiber coupler has the same diameter within the tapering region.

In some embodiments, the active optical module may have a forward pumping mode in which the tapering region of the optical fiber coupler is disposed in a direction from the first optical device to the second optical device.

In other embodiments, the active optical module may have a backward pumping mode in which the tapering region of the optical fiber coupler is disposed in a direction from the second optical device to the first optical device.

In still other embodiments, the active optical module may have a bidirectional pumping mode in which the tapering regions of a plurality of optical fiber couplers are disposed in opposite directions to each other.

In even other embodiments, the active optical module may have a multi forward pumping mode in which the tapering regions of a plurality of optical fiber couplers are disposed in a direction from the first optical device to the second optical device.

In yet other embodiments, the first optical device and the second optical device may comprise a first mirror and a second mirror, respectively.

In further embodiments, active optical modules may further comprise a modulator disposed in the first optical fiber between the first mirror and the second mirror.

In still further embodiments, the first optical device and the second optical device may comprise a first isolator and a second isolator, respectively.

### BRIEF DESCRIPTION OF THE DRAWINGS

The accompanying drawings are comprised to provide a further understanding of the present invention, and are incorporated in and constitute a part of this specification. The drawings illustrate exemplary embodiments of the present invention and, together with the description, serve to explain principles of the present invention. In the drawings:

FIGS. 1 through 7 are diagrams illustrating a method for manufacturing an optical fiber coupler according to an embodiment of the present invention;

FIGS. 8 and 9 are cross-sectional views illustrating optical fiber couplers according to other embodiments of the present invention;

FIGS. 10A through 10D are diagrams illustrating an active optical module according to a first embodiment of the present invention;

FIGS. 11A through 11D are diagrams illustrating an active optical module according to a second embodiment of the present invention;

FIGS. 12A through 12D are diagrams illustrating an active optical module according to a third embodiment of the present invention; and

FIGS. 13A through 13D are diagrams illustrating an active optical module according to a fourth embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art.

In the drawings, the dimensions of layers and regions are exaggerated for clarity of illustration. It will also be understood that when a layer (or film) is referred to as being ‘on’ another layer or substrate, it can be directly on the other layer or substrate, or intervening layers may also be present. Further, it will be understood that when a layer is referred to as being ‘under’ another layer, it can be directly under, and one or more intervening layers may also be present. In addition, it will also be understood that when a layer is referred to as being ‘between’ two layers, it can be the only layer between the two layers, or one or more intervening layers may also be present. Like reference numerals refer to like elements throughout.

In the following description, the technical terms are used only for explain a specific exemplary embodiment while not limiting the present invention. The terms of a singular form may comprise plural forms unless referred to the contrary. The meaning of “include,” “comprise,” “including,” or “comprising,” specifies a property, a region, a fixed number, a step, a process, an element and/or a component but does not exclude other properties, regions, fixed numbers, steps, processes, elements and/or components. It will be understood that when an element such as a layer, film, region, or substrate is referred to as being “on” another element, it can be directly on the other element or intervening elements may also be present.

Additionally, the embodiment in the detailed description will be described with reference to sectional views and/or plan views as ideal exemplary views of the present invention. In the figures, the dimensions of layers and regions are exaggerated for clarity of illustration. Accordingly, shapes of the exemplary views may be modified according to manufacturing techniques and/or allowable errors. Therefore, the embodiments of the present invention are not limited to the specific shape illustrated in the exemplary views, but may comprise other shapes that may be created according to manufacturing processes. For example, an etching region illustrated as angular may have a round shape or a certain curvature. Therefore, regions exemplified in the drawings have general properties, and are used to illustrate a specific shape of a device region. Thus, this should not be construed as limiting the scope of the present invention.

A method for manufacturing an optical fiber coupler according to an embodiment of the present invention may comprise a method of conically etching second optical fibers coupled to the circumference of a first optical fiber.

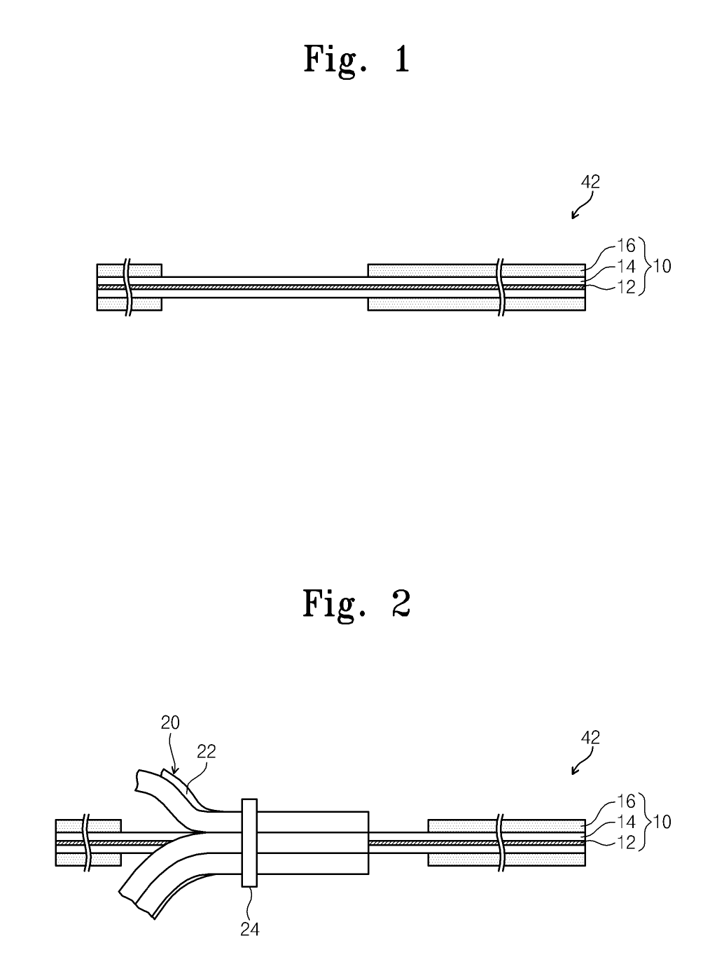

FIGS. 1 through 7 are diagrams illustrating a method for manufacturing an optical fiber coupler 40 according to an embodiment of the present invention. Here, a first optical fiber 10 has been shown in a transmitting cross-sectional view, and second optical fibers 20 have been shown in a profile.

Referring to FIG. 1, the first optical fiber 10 may comprise a photonic crystal fiber or a double cladding optical fiber comprising a first cladding 14 and a second cladding 16 surrounding a first core 12. The first core of the double cladding optical fiber may comprise silica glass added with rare-earth elements. In case of the double cladding optical fiber, the first cladding 14 may have a lower refractive index than the first core 12. The first cladding 14 may comprise silica glass. A difference of the refractive index between the first core 12 and the first cladding 14 may be below about 0.005. The second cladding 16 may comprise fluorinated polymer. Similarly, the first core 12 of the photonic crystal fiber may comprise silica glass added with rare-earth elements. The first cladding 14 may comprise silica glass in which numerous pores are thickly arranged in a longitudinal direction. The second cladding 16 may comprise silica glass having the same refractive index as the first core 12. The second cladding 16 may be removed by an etching method. The second cladding 16 may be removed by etching or chemical etching method. Also, the second cladding 16 may be removed by a mechanical method. For example, the first optical fiber 10 may allow the first cladding 14 to be exposed by about 1 cm to about 10 cm in the longitudinal direction.

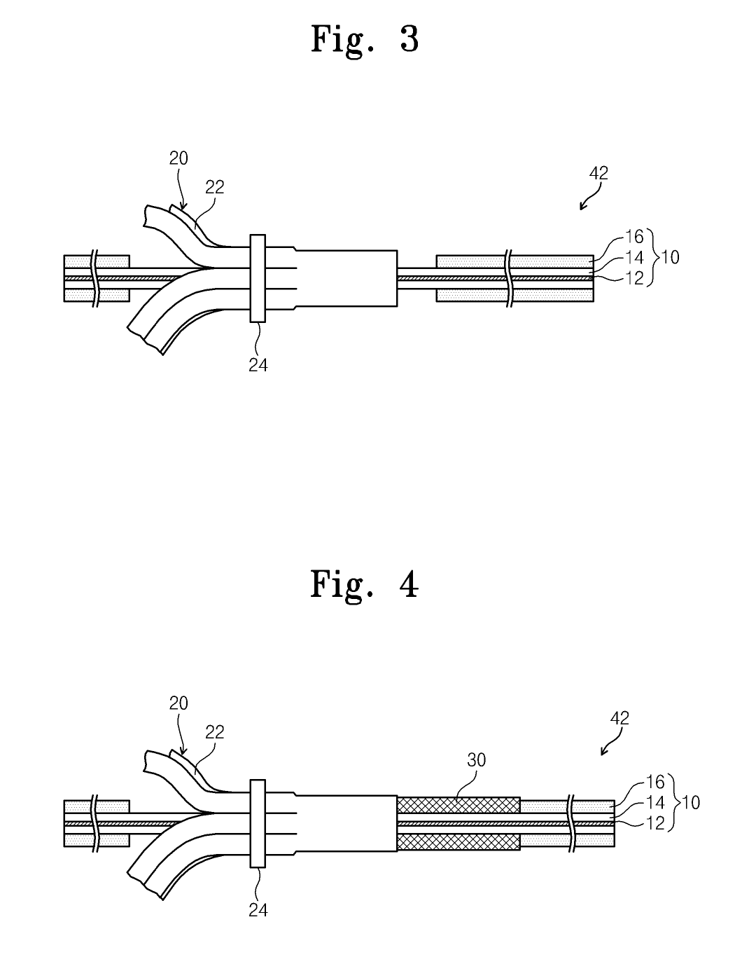

Referring to FIG. 2, at least one second optical fibers 20 may be bundled around the first cladding 14. The second optical fibers 20 may comprise second cores 22. The second optical fibers 20 may be bundled along with the first optical fiber 10 by a clamp 24. The clamp 24 may bundle the second optical fibers 20 around the first optical fiber 10. The second optical fibers 20 may be bound in a mono-layer or multi-layer around the first cladding 14 of the first optical fiber 10. The second optical fibers 20 may be compactly bound to the first cladding 14 of the first optical fiber 10. One end of the second optical fibers 20 may be fixed at the first cladding 14, and the other end of the second optical fibers 20 may be connected to a pumping light source (not shown). The second optical fibers 20 may be obliquely connected to the first cladding 14. The second optical fibers 20 may comprise multi mode fibers or hard clad fibers comprising polymer clad and silica core or fluoride silica clad and silica core. First, the multi mode fibers may comprise optical fibers in which the mode of light transferred in the second cores 22 is multiple. The second cores 22 of the multi mode fibers may have diameters of about 50 μm to about 100 μm. Next, the optical fibers having fluoride silica clad and silica core may comprise second cores 22 having diameters of about 105 μm and claddings having diameters of about 125 μm. The Numerial Aperture (NA) between the second cores 22 and the claddings may be about 0.15 or about 0.22. The second cores 22 may comprise pure silica glass, and the claddings may comprise silica glass doped with fluorine.

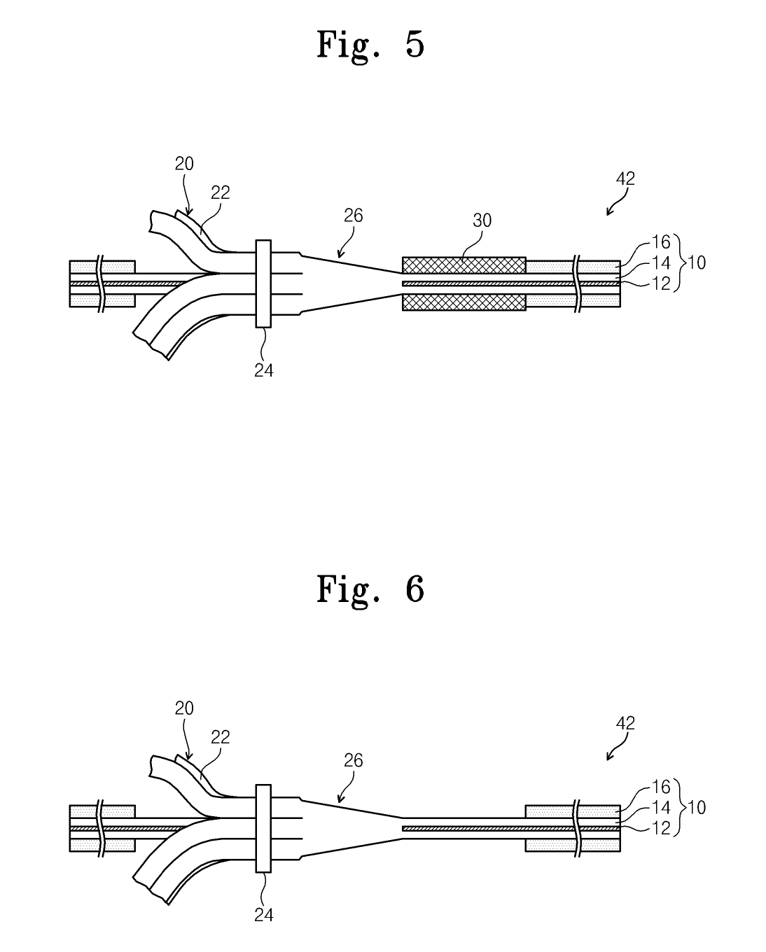

Referring to FIG. 3, the second optical fibers 20 around the first cladding 14 may be melted. The second optical fibers 20 may be fused to the circumference of the first cladding 14 by micro-torches, electric heaters, and CO2 lasers. Micro-torches may melt the second optical fibers 20 with flame of gas lead-in type. Electrical heaters may melt the second optical fibers 20 with high temperature. CO2 lasers may melt the second optical fibers 20 more precisely than micro-torches. The second optical fibers 20 may be fused to the circumference of the first cladding 14 in a circular or floral pattern.

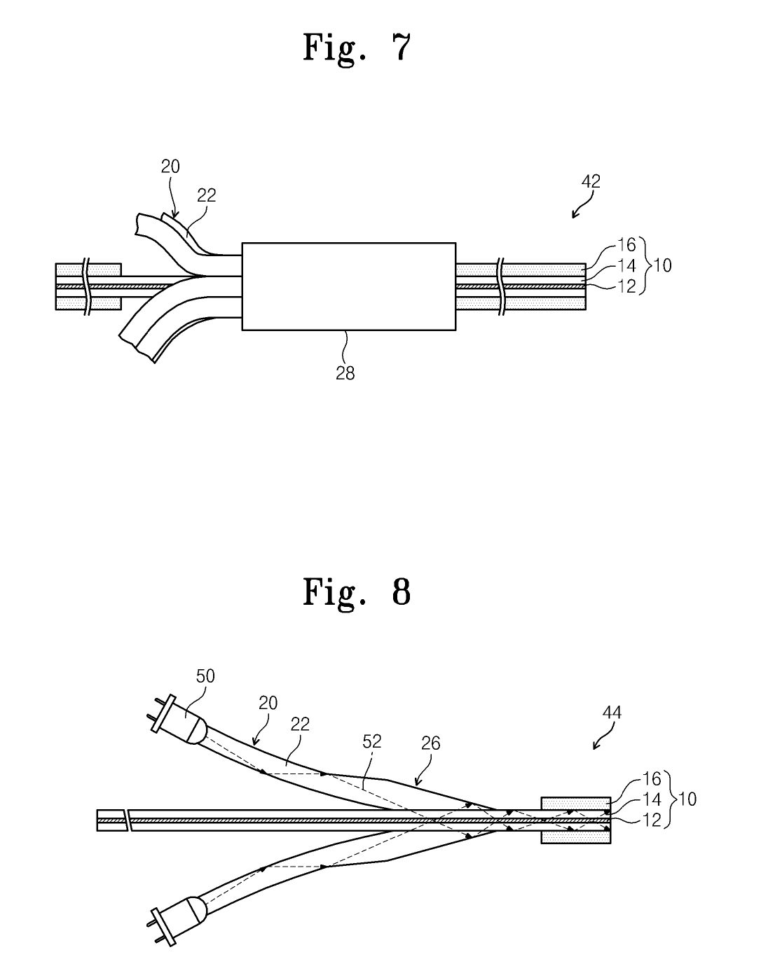

Referring to FIG. 4, a protection layer 30 may be coated over the first cladding 14 exposed at the second optical fibers 20. The protection layer 30 may overlap the second cladding 16 and the second optical fibers 20 fused to the first cladding 14. For example, the protection layer 30 may comprise thermoplastics and polymer such as sol-gel coating solution.

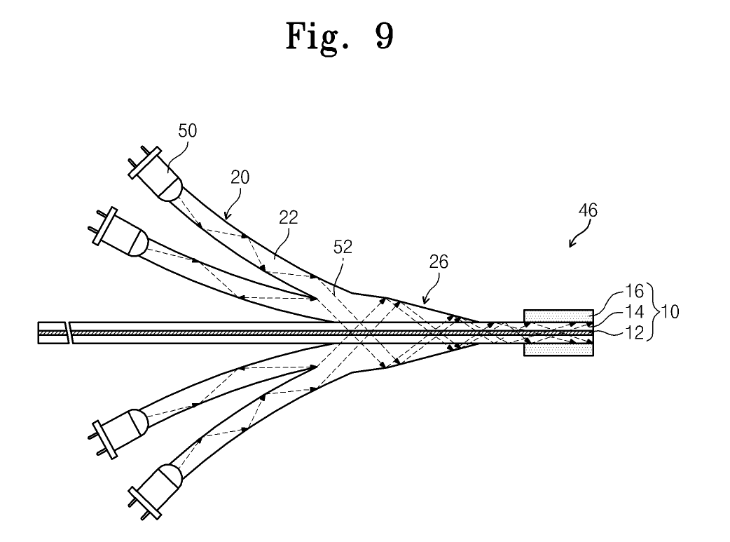

Referring to FIG. 5, the second optical fibers 20 around the first cladding 14 may be conically etched. The second optical fibers 20 may be conically etched by a wet etching method or a laser etching method. Accordingly, the second optical fibers 20 may have a tapering region 26 coupled to the first cladding 14 of the first optical fiber 10. In the wet etching method, the second optical fibers 20 may be removed using hydrofluoric acid or buffered etching solution comprising hydrofluoric acid. Hydrofluoric acid or buffered etching solution may chemically etch the second optical fibers 20. The wet etching method may comprise a dip method in which the second optical fibers 20 are dipped in an etching solution. The tapering region 26 may be formed according to the variation of time when the second optical fibers 20 are dipped in an etching solution. For example, the tapering region 26 may be formed by slowly pulling up the second optical fibers 20 from hydrofluoric acid or buffered etching solution to the atmosphere. The second optical fibers 20 may be more shortly exposed to the etching solution as becoming closer to the clamp 24, and may be longer exposed to the etching solution as becoming closer to the protection layer 30. The laser etching method may remove the second optical fibers 20 with a femto-second laser. The femto-second laser may etch the second optical fibers 20. The femto-second laser may conically etch the second optical fibers 20 around the first cladding 14 while rotating. The protection layer 30 may protect the first cladding 14 upon etching of the second optical fibers 20.

Accordingly, in the methods for manufacturing an optical fiber coupler 40 according to the embodiments of the present invention, the second optical fibers 20 coupled to the first cladding 14 of the first optical fiber 10 may be etched by a wet etching method or a laser etching method to conically form the second optical fibers 20 around the first cladding 14.

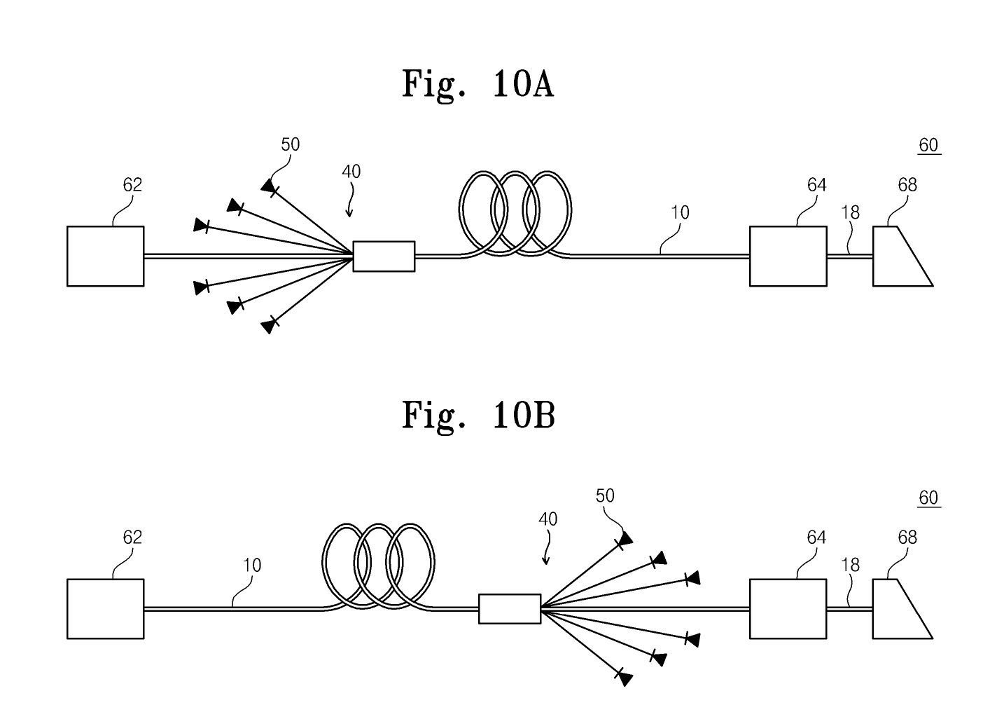

Referring to FIG. 6, after the protection layer 30 is removed, the surface of the tapering region 26 of the second optical fibers 20 may be thermally treated. Stepped layers generated during etching may be removed from the tapering region 26 of the second optical fibers 20. The surface treatment of the second optical fibers 20 may be performed by a micro-torch or a CO2 laser. The surface treatment of the tapering region 26 may reduce loss of light delivered through the second optical fibers 20. Since the protection layer 30 may become an obstacle upon surface treatment of the second optical fibers 20, the protection layer 30 may be removed prior to the surface treatment of the tapering region 26.

Accordingly, in the methods for manufacturing an optical fiber coupler 40 according to the embodiments of the present invention, efficiency of light supplied from the second optical fibers 20 to the first optical fiber 10 can be increased by treating the surface of the second optical fibers 20 that is conically etched at the first cladding 14 of the first optical fiber 10.

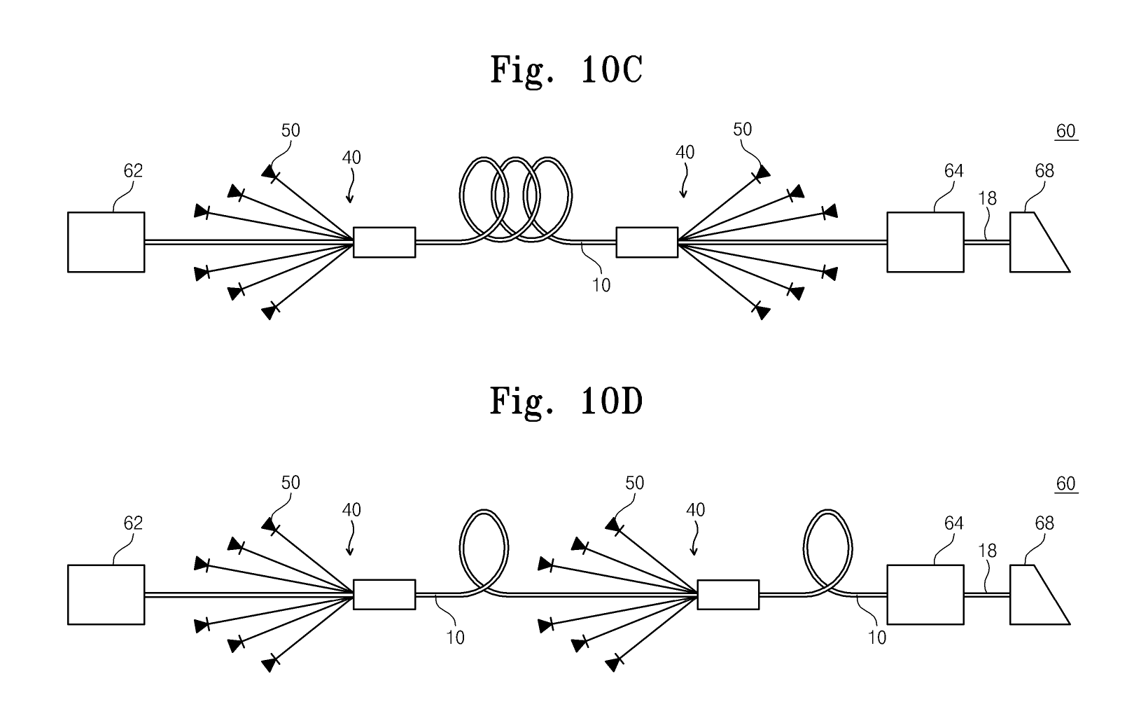

Referring to FIG. 7, the tapering region 26 of the second optical fibers 20 may be packaged with a sealing device 28. The sealing device 28 may cover from the second cladding 16 of the first optical fiber 10 to the second optical fibers 20. The sealing device 28 may protect the first optical fiber 10 and the second optical fibers 20 from an external force or shock. For example, the sealing device 28 may comprise a metallic case such as aluminium.

On the other hand, the optical fiber coupler 40 according to an embodiment of the present invention may have a side pumping structure in which pump light is supplied through at least one of the second optical fibers 20 coupled to a side surface of the first optical fiber 10. Hereinafter, a connection structure of a pump light source and a traveling direction of pump light 52 will be described in detail with reference to the accompanying drawing.

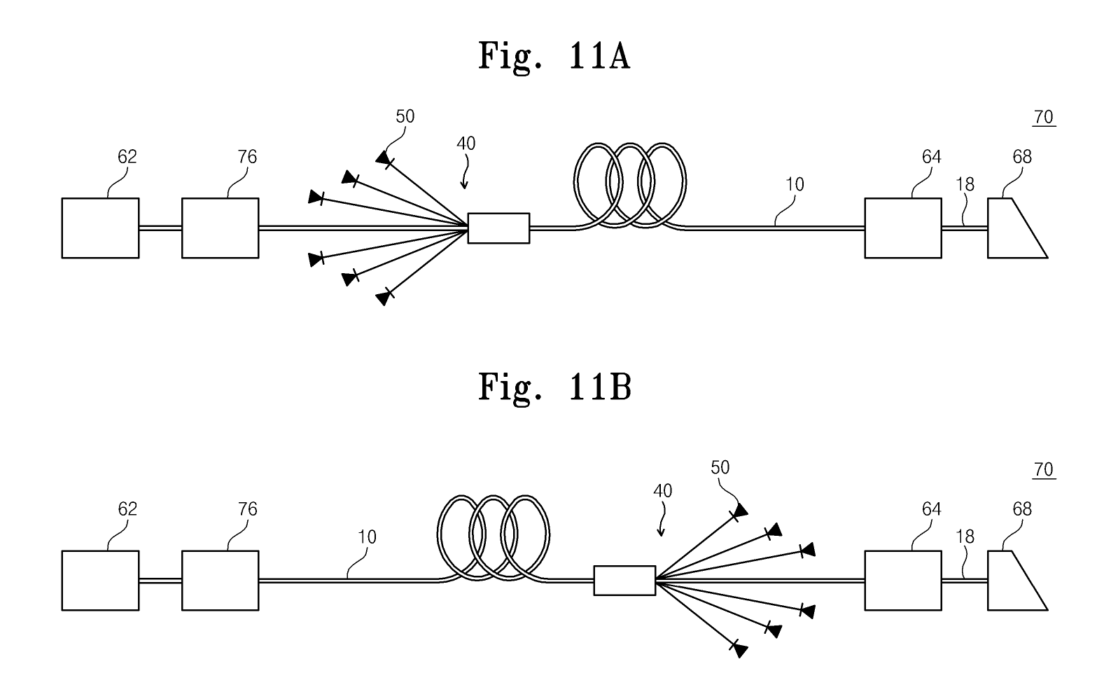

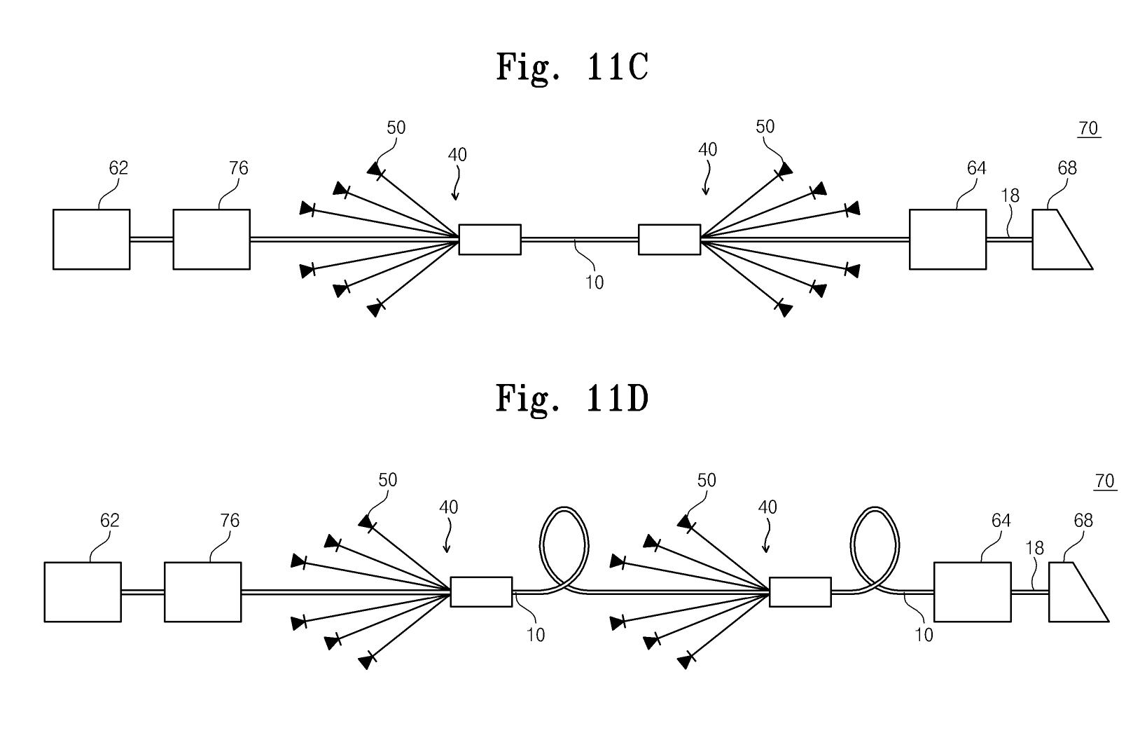

FIGS. 8 and 9 are cross-sectional views illustrating optical fiber couplers 44 and 46 according to other embodiments of the present invention.

Referring to FIGS. 8 and 9, the optical fiber couplers 44 and 46 according to other embodiments of the present invention may comprise a first optical fiber 10 comprising a first core 12 and a first cladding 14 surrounding the first core 12, and second optical fibers 20 coupled to the first cladding 14 and having a tapering region 26 with a tapered cylindrical shape around the first cladding 14.

The first optical fiber 10 may comprise a double cladding optical fiber in which the first cladding 14 and a second cladding surround the first core 12 sequentially. The first core 12 may not have a discontinuous cutting surface at the inside or outside of the tapering region 26 to which the second optical fibers 20 are coupled, and may have a fixed diameter in the tapering region 26. The first core 12 may comprise a single mode core or a multi mode core. The first core 12 may have a refractive index higher than second cores 22 of the second optical fibers 20.

The first and second claddings 14 and 16 may have refractive indexes lower than the first core 12. The first cladding 14 and the second cladding 16 may have silica glass or fluorinated polymer. The first cladding 14 may have a refractive index higher than the second cladding 16. For example, the first cladding 14 may comprise silica glass, and the second cladding 16 may comprise fluorinated polymer. The second cladding 16 may be easily removed from the first cladding 14.

The second optical fibers 20 may comprise a multi mode fiber comprising the second cores 22 of multi mode. The second optical fibers 20 may be coupled to the circumference of the first cladding 14 in a mono- (FIG. 8) or multi-layer (FIG. 9). The second cores 22 may have the same refractive index as the first cladding 14. The second cores 22 may be formed of the same material as the first cladding 14. Although not shown in FIGS. 8 and 9, the second optical fibers 20 may comprise a cladding surrounding the second cores 22. When the second optical fibers 20 are coupled to the circumference of the first cladding 14 in a mono-layer (FIG. 8) or multi-layer (FIG. 9), the second core 22 may be directly coupled to the first cladding 14 after the cladding of the second optical fibers 20 is removed. Also, silica optical fiber without a core cladding structure may be spliced to the second optical fibers 20, and then the fused silica optical fiber may be coupled to the circumference of the first cladding 14 in a mono-layer (FIG. 8) or multi-layer (FIG. 9).

Accordingly, since the first core 12 is continuous without a cutting surface in an area of the first optical fiber 10 in which the second optical fibers 20 of multi mode are coupled in a tapered cylindrical structure, the optical fiber couplers 44 and 46 according to the other embodiments of the present invention can prevent an optical loss caused by a typical coupling mismatch between a core of a center optical fiber in bundle and a core of a double cladding optical fiber, having different diameters from each other.

The second optical fibers 20 may deliver pump light 52 supplied from a pump light source 50 to the first optical fiber 10. The pump light source 50 may generate the pump light 52. The pump light source 50 may comprise a Laser Diode (LD). The LD may be manufactured in a bar or stack type. The pump light source 50 may generates the pump light 52 having a wave band of at least one of about 808 nm, about 915 nm, about 950 nm, about 980 nm, and about 1,480 nm according to the types of light emitting materials.

The pump light 52 may be supplied to the first optical fiber 10 through the second cores 22 of the second optical fibers 20. The pump light 52 may be incident from the tapering region 26 of the second optical fibers 20 to the first cladding 14 of the first optical fiber 10. This is because the refractive index of the first cladding 14 is equal to the refractive index of the second optical fibers 20. The pump light 52 may be absorbed into the first core 12 while traveling from the second optical fibers 20 to the first cladding 14 of the first optical fiber 10.

Accordingly, the optical fiber couplers 44 and 46 according to another embodiment of the present invention can prevent the pump light 52 from being reflected at a boundary because the refractive index of the first cladding 14 of the first optical fiber 10 has the substantially same as the second optical fibers 20.

The first core 12 may comprise an active material that absorbs the pump light 52 incident from the second optical fibers 20, and may generate an Amplified Spontaneous Emission (ASE). The rare-earth elements may absorb the pump light 52 supplied through the second optical fibers 20 to emit laser light of a single wavelength while electrons excited to a metastable state are stabilized. The rare-earth elements may comprise at least one of Er, Yb, and Tm. Er, Yb, and Tm may emit laser light of wave band of about 1,550 nm, about 1,080 nm, and 2,000 nm, respectively.

The first core 12 may absorb the pump light 52 traveling in a direction of coupling of the second optical fibers 20 to the first cladding 14. For example, the pump light 52 may travel along the first cladding 14 in a declined direction of the second optical fibers 20 to be absorbed into the first core 12. The traveling direction of the pump light 52 may be identical to the direction of coupling of the second optical fibers 20 to the first optical fiber 10.

Accordingly, the optical fiber couplers 44 and 46 according to another embodiment may implement an optical fiber laser and an optical fiber amplifier, having a forward pumping mode and a backward pumping mode, according to a direction of the output of the laser light. The optical fiber laser and the optical fiber amplifier may have a bidirectional pumping mode in which the forward and backward pumping modes are mixed, and a multi forward pumping mode. Here, the direction of coupling of the second optical fibers 20 to the first optical fiber 10 may be defined as an incident direction of the pump light 52. In the forward pumping mode, the incident direction of the pump light 52 may be identical to the direction of the output of formed laser light. In the backward pumping mode, the incident direction of the pump light 52 may be opposite to the direction of the output of formed laser light.

Accordingly, the type of an active optical module that is operable may vary according to the types of optical devices formed at both ends of the first optical fiber 10 of the optical fiber couplers 44 and 46 according to other embodiments of the present invention

Hereinafter, embodiments of an active optical module having various types of pumping modes according to the types of optical devices connected to the both ends of a first optical fiber 10 formed with an optical fiber coupler 40 will be described in detail with reference to the accompanying drawings.

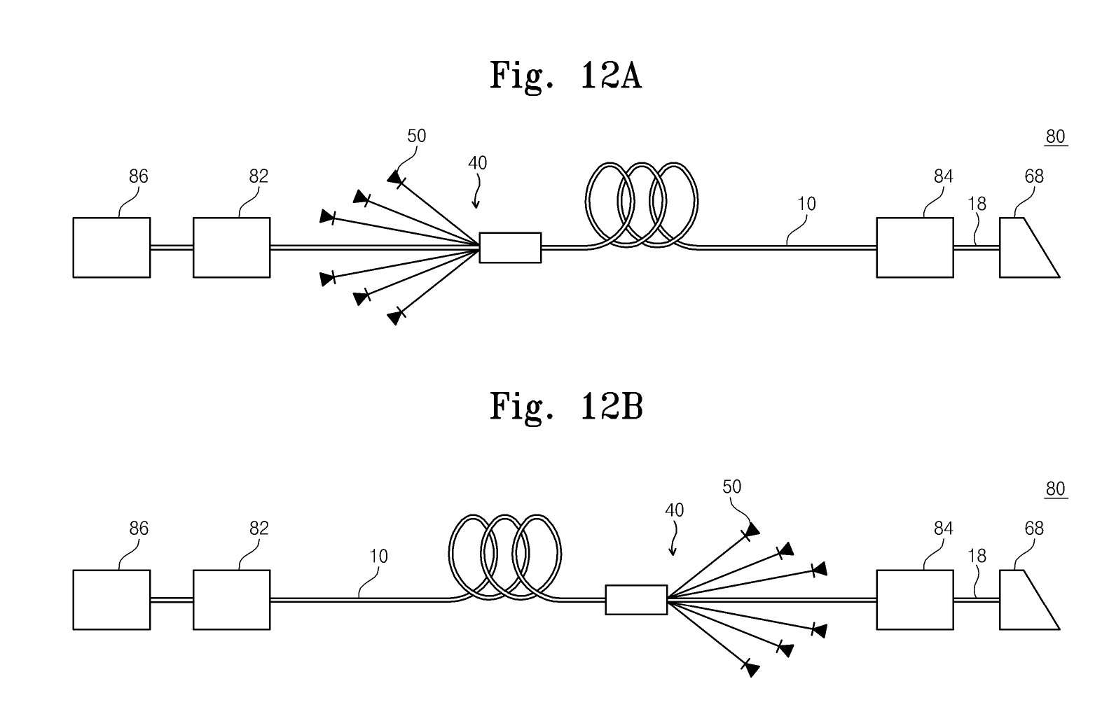

FIGS. 10A through 10D are diagrams illustrating an active optical module 60 according to a first embodiment of the present invention.

Referring to FIGS. 10A through 10D, an active optical module 60 according to a first embodiment of the invention may comprise a continuous output laser 60 configured with first and second mirrors 62 and 64 at both ends of the first optical fiber 10 disclosed in FIGS. 8 and 9. The output laser 60 may be a continuous laser having a single wave band. Specifically, when pump light 52 is incident to a first core 12 of the first optical fiber 10 through the pump light source 50 and the second optical fibers 20, laser may be oscillated along the first core of the optical fiber 10 between the first and second mirrors 62 and 64.

The first and second mirrors 62 and 64 may resonate the laser light oscillated from the first optical fiber 10. The first mirror 62 may reflect laser light of about 100%, and the second mirror 62 may reflect laser light of about 5% to about 20%. The first mirror 62 may comprise a Fiber Bragg Grating (FBG) or a full mirror perfectly reflecting the laser light. The second mirror 64 may comprise an output coupler transmitting partially laser light such as FBG and mirror with partial reflectivity. Laser light oscillated between the first mirror 62 and the second mirror 64 may be outputted to an end cap 68 or a collimator through a pigtail optical fiber 18 extending from the second mirror 64.

Referring to FIG. 10A, the active optical module 60 according to the first embodiment of the present invention may have a forward pumping mode in which the optical fiber module 40 is disposed in a direction from the first mirror 62 to the second mirror 64. The laser light may be outputted from the second mirror 64 to the end cap 68 through the pigtail optical fiber 18 of the first optical fiber 10. The optical fiber coupler 40 may be disposed adjacent to the first mirror 62. The pump light 52 may be sufficiently absorbed while traveling along the first optical fiber 10 extending from the first mirror 62 to the second mirror 64. Accordingly, in the forward pumping mode, the traveling direction of the pump light 52 in the first optical fiber 10 may be identical to the output direction of the laser light.

Referring to FIG. 10B, the active optical module 60 according to the first embodiment of the present invention may have a backward pumping mode in which the optical fiber coupler 40 is disposed in a direction from the second mirror 64 to the first mirror 62. The optical fiber coupler 40 may be coupled to the first optical fiber 10 approaching the second mirror 64. The pump light 52 delivered through the second optical fibers 20 may be sufficiently absorbed while traveling along the first optical fiber 10 connected from the second mirror 64 to the first mirror 62. Accordingly, in the backward pumping mode, the traveling direction of the pump light 52 in the first optical fiber 10 may be opposite to the output direction of the laser light.

Referring to FIG. 10C, the active optical module 60 according to the first embodiment of the present invention may have a bidirectional pumping mode in which a plurality of optical fiber couplers 40 are disposed opposite to each other in the first optical fiber 10 approaching the first mirror 62 and the second mirror 64, respectively. The plurality of optical fiber couplers 40 may supply pump light 52 to the first optical fiber 10 between the first mirror 62 and the second mirror 64 in opposite directions to each other. The plurality of optical fiber couplers 40 may be disposed in a forward direction in the first optical fiber 10 adjacent to the first mirror 62, and may be disposed in a backward direction in the optical fiber 10 adjacent to the second mirror 64, respectively. The pump light 52 may be sufficiently absorbed into the first core 12 while traveling along the first optical fiber 10 between the first mirror 62 and the second mirror 64. Accordingly, in the bidirectional pumping mode, laser light may be generated by the pump light 52 delivered in opposite directions to each other in the optical fiber 10 between the first mirror 62 and the second mirror 64.

Referring to FIG. 10D, the active optical module 60 according to the first embodiment of the present invention may have a multi forward pumping mode in which a plurality of optical fiber couplers 40 are disposed in the same direction in the first optical fiber 10. The plurality of optical fiber couplers 40 may deliver pump light 52 of the same direction to the first optical fiber 10 in a direction from the first mirror 62 to the second mirror 64. The plurality of optical fiber couplers 40 may be disposed in a forward direction between the first mirror 62 and the second mirror 64. When the pump light supplied from the first optical fiber coupler 40 is depleted in the first optical fiber 10, pump light may be supplied from the second optical fiber coupler 40 to progressively increase the output of the laser light. The intensity of the pumping light supplied through the second optical fiber coupler 40 may be greater than that of the pumping light supplied from the first optical fiber coupler 40.

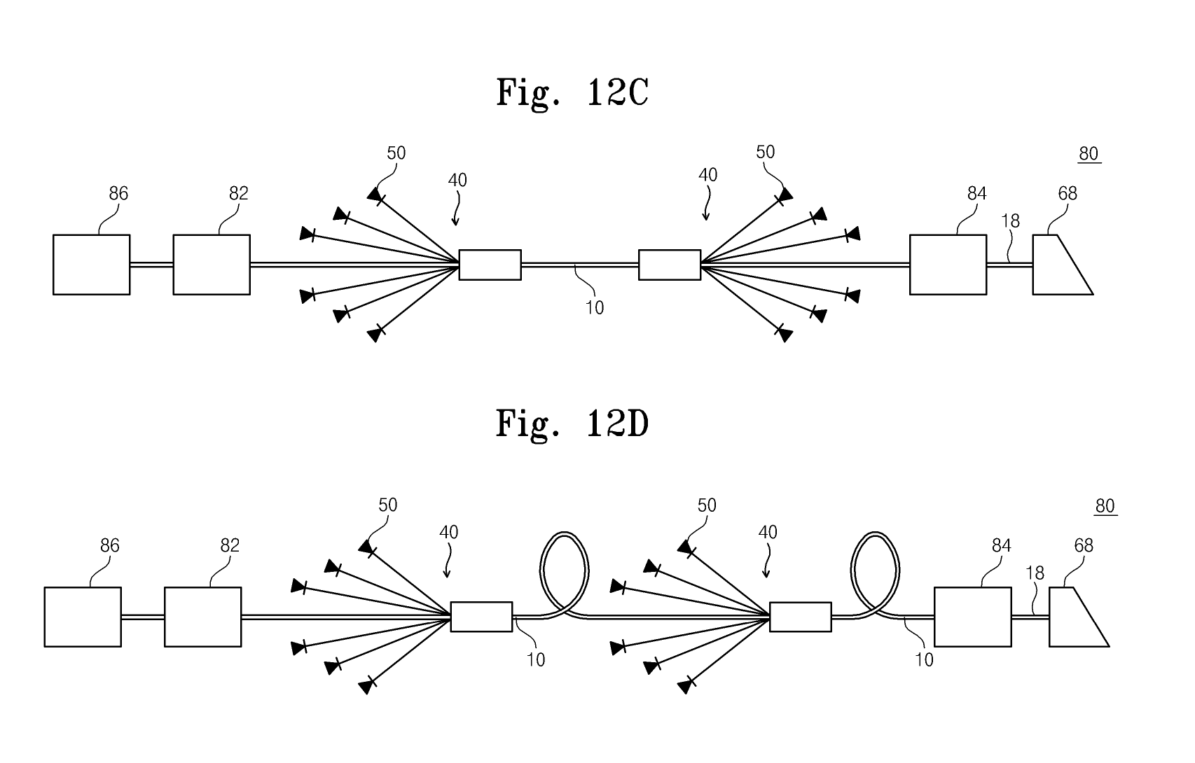

FIGS. 11A through 11D are diagrams illustrating an active optical module 70 according to a second embodiment of the present invention.

Referring to FIGS. 11A through 11D, an active optical module 70 according to a second embodiment of the present invention may comprise a Q switching laser 70 or a mode locking laser comprising a first mirror 62 and a modulator 76 coupled to an optical fiber 10 at one side of the optical fiber coupler 40 shown in FIGS. 8 and 9, and a second mirror 64 coupled to the optical fiber 10 at the other side of the optical fiber coupler 40. The Q switching laser 70 or the mode locking laser may be a pulsed laser. Laser light may be oscillated along the first core 12 of the first optical fiber 10 between the first mirror 62 and the second mirror 64. The first and second mirrors 62 and 64 may resonate the laser light.

The modulator 76 may modulate laser using analog or digital electrical signals. The modulator 76 may switch laser oscillated between the first mirror 62 and the second mirror 64 to a pulsed laser. The pulsed laser light may be generated according to periodic on/off operations of the modulator 76. For example, the pulsed laser light may be oscillated when the modulator 76 is turned on, and may not be generated when the modulator 76 is turned off.

The first mirror 62 may reflect laser light of about 100%, and the second mirror 62 may reflect laser light of about 5% to about 20%. The first mirror 62 may comprise a Fiber Bragg Grating (FBG) or a full mirror perfectly reflecting the laser light. The second mirror 64 may comprise an output coupler transmitting partially laser light such as FBG and mirror with partial reflectivity. Laser oscillated between the first mirror 62 and the second mirror 64 may be outputted to an end cap 68 or a collimator through a pigtail optical fiber 18 extending from the second mirror 64.

Referring to FIG. 11A, the active optical module 70 according to the second embodiment of the present invention may have a forward pumping mode in which the optical fiber module 40 is disposed in a direction from the first mirror 62 to the second mirror 64. Here, the pulse laser may be outputted from the second mirror 64 to the end cap 68 through the pigtail optical fiber 18 of the first optical fiber 10. The optical fiber coupler 40 may be disposed in the first optical fiber 10 adjacent to the first mirror 62. Pump light 52 may be sufficiently absorbed while traveling along the first optical fiber 10 connected from the first mirror 62 to the second mirror 64. Accordingly, in the forward pumping mode, the traveling direction of the pump light 52 in the first optical fiber 10 may be identical to the output direction of the pulse laser light.

Referring to FIG. 11B, the active optical module 70 according to the second embodiment of the present invention may have a backward pumping mode in which the optical fiber coupler 40 is disposed in a direction from the second mirror 64 to the first mirror 62. The optical fiber coupler 40 may be coupled to the first optical fiber 10 approaching the second mirror 64. The pump light 52 may be sufficiently absorbed while traveling along the first optical fiber 10 connected from the second mirror 64 to the first mirror 62. Accordingly, in the backward pumping mode, the traveling direction of the pump light 52 in the first optical fiber 10 may be opposite to the output direction of the laser light.

Referring to FIG. 11C, the active optical 70 module according to the second embodiment of the present invention may have a bidirectional pumping mode in which a plurality of optical fiber couplers 40 are disposed opposite to each other in the first optical fiber 10 approaching the first mirror 62 and the second mirror 64, respectively. The plurality of optical fiber couplers 40 may supply pump light 52 to the first optical fiber 10 between the first mirror 62 and the second mirror 64 in opposite directions to each other. The plurality of optical fiber couplers 40 may be disposed in a forward direction in the first optical fiber 10 adjacent to the first mirror 62, and may be disposed in a backward direction in the optical fiber 10 adjacent to the second mirror 64, respectively. The pump light 52 may be sufficiently absorbed into the first core 12 while traveling along the first optical fiber 10 between the first mirror 62 and the second mirror 64. Accordingly, in the bidirectional pumping mode, pulse laser may be oscillated by the pump light 52 delivered in opposite directions to each other in the optical fiber 10 between the first mirror 62 and the second mirror 64.

Referring to FIG. 11D, the active optical module 70 according to the second embodiment of the present invention may have a multi forward pumping mode in which a plurality of optical fiber couplers 40 are disposed in the same direction in the first optical fiber 10 between the first mirror 62 and the second mirror 64. The plurality of optical fiber couplers 40 may deliver pump light 52 of the same direction to the first optical fiber 10. The plurality of optical fiber couplers 40 may be disposed in a forward direction between the first mirror 62 and the second mirror 64. When the pump light supplied from the first optical fiber coupler 40 is depleted in the first optical fiber 10, pump light may be supplied from the second optical fiber coupler 40 to progressively increase the output of the laser light. The intensity of the pumping light supplied through the second optical fiber coupler 40 may be greater than that of the pumping light supplied from the first optical fiber coupler 40.

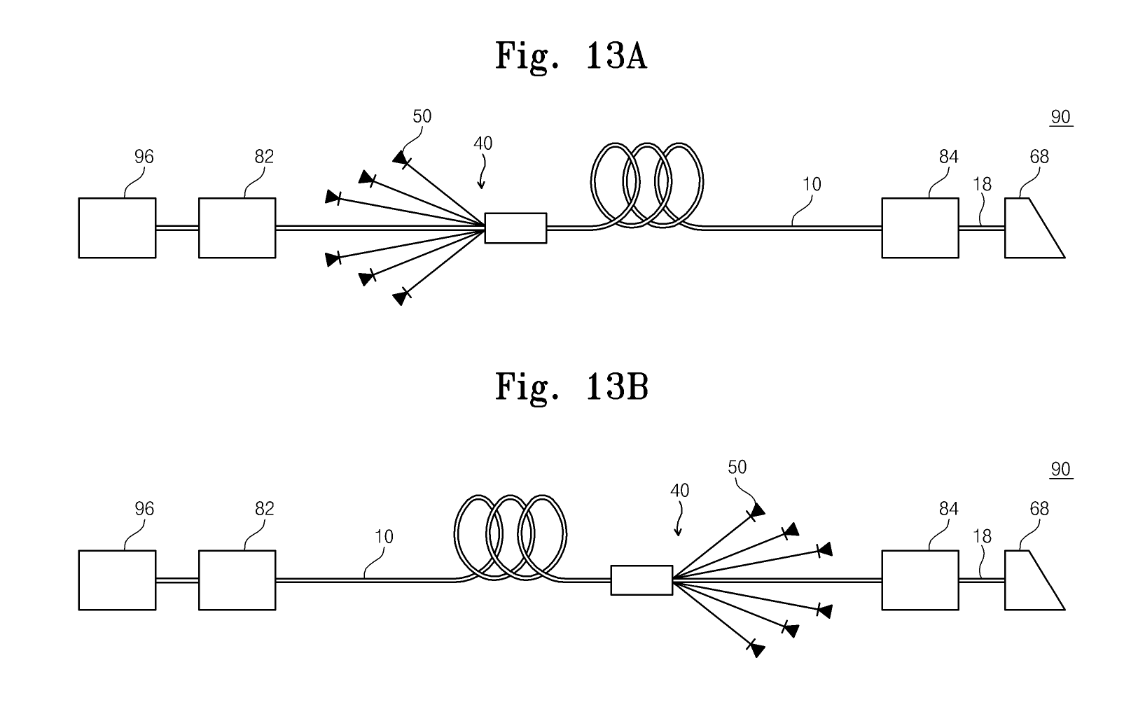

FIGS. 12A through 12D are diagrams illustrating an active optical module 80 according to a third embodiment of the present invention.

Referring to FIGS. 12A through 12D, an active optical module 80 according to a third embodiment of the present invention may comprise a laser optical amplifier 80 comprising a signal source 86 and a first isolator 82 at one side of the optical fiber coupler 40 shown in FIGS. 8 and 9, and a second isolator 84 coupled to the optical fiber 10 at the other side of the optical fiber coupler 40. The laser optical amplifier 80 may amplify laser light 86 using pump light 52 delivered from the optical fiber coupler 40. The signal source 86 may comprise a semiconductor light source, an output end of another laser optical fiber amplifier 80, and an optical fiber laser. The pump light source 50 may supply the pump light 52 to the first optical fiber 10. Signals inputted from the signal source 86 may be amplified to output laser. Accordingly, the laser optical amplifier 80 may output a laser amplified according to the signals of the signal source 86.

The first and second isolators 82 and 84 may deliver laser light to an end cap 68 along the first optical fiber 10. The first isolator 82 may pass a signal outputted from the signal source 86. On the other hand, the first isolator 82 may block any light returning to the signal source 86. The second isolator 84 may pass laser light traveling to an end cap 68 through a pigtail optical fiber 18. On the other hand, the second isolator 84 may block any light returning to the first optical fiber 10 through the pigtail optical fiber 18. The second isolator 84 may be omitted.

Referring to FIG. 12A, the active optical module 80 according to the third embodiment of the present invention may have a forward pumping mode in which the optical fiber module 40 is disposed in a direction from the first isolator 82 to the second isolator 84. Here, the output laser light may be outputted from the second isolator 84 to the end cap 68 through the pigtail optical fiber 18. The optical fiber coupler 40 may be disposed in the first optical fiber 10 adjacent to the first isolator 82. Pump light 52 may be sufficiently absorbed while traveling along the first optical fiber 10 connected from the first isolator 82 to the second isolator 84. Accordingly, in the forward pumping mode, the traveling direction of the pump light 52 in the first optical fiber 10 may be identical to the output direction of the output laser that has been amplified.

Referring to FIG. 12B, the active optical module 80 according to the third embodiment of the present invention may have a backward pumping mode in which the optical fiber coupler 40 is disposed in a direction from the second isolator 84 to the first isolator 82. The optical fiber coupler 40 may be coupled to the first optical fiber 10 approaching the second isolator 84. The pump light 52 may be sufficiently absorbed while traveling along the first optical fiber 10 extending from the second isolator 84 to the first isolator 82. Accordingly, in the backward pumping mode, the traveling direction of the pump light 52 in the first optical fiber 10 may be opposite to the output direction of the output laser that has been amplified.

Referring to FIG. 12C, the active optical module 80 according to the third embodiment of the present invention may have a bidirectional pumping mode in which a plurality of optical fiber couplers 40 are disposed opposite to each other in the first optical fiber 10 approaching the first isolator 82 and the second isolator 84, respectively. The first isolator 82 and the second isolator 84 may block any light that travels in the backward direction. The plurality of optical fiber couplers 40 may be disposed in the forward direction in the first optical fiber 10 adjacent to the first isolator 82, and may be disposed in the backward direction in the optical fiber 10 adjacent to the second isolator 84. The pump light 52 may be absorbed into the first core 12 while traveling along the first optical fiber 10 between the first isolator 82 and the second isolator 84. Accordingly, in the bidirectional pumping mode, laser light amplified by the pump light 52 delivered in opposite directions to each other in the optical fiber 10 between the first isolator 82 and the second isolator 84 may be oscillated.

Referring to FIG. 12D, the active optical module 80 according to the third embodiment of the present invention may have a multi forward pumping mode in which a plurality of optical fiber couplers 40 are disposed in the optical fiber 10 between the first isolator 82 and the second isolator 84. The plurality of optical fiber couplers 40 may be disposed in the same direction between the first isolator 82 and the second isolator 84. The plurality of optical fiber couplers 40 may deliver the pump light 52 from the first isolator 82 to the second isolator 84. The plurality of optical fiber couplers 40 may be disposed between the first isolator 82 and the second isolator 84. When the pump light supplied from the first optical fiber coupler 40 is depleted in the first optical fiber 10, pump light may be supplied from the second optical fiber coupler 40 to progressively increase the amplification of the laser. The intensity of the pumping light supplied through the second optical fiber coupler 40 may be greater than that of the pumping light supplied from the first optical fiber coupler 40.

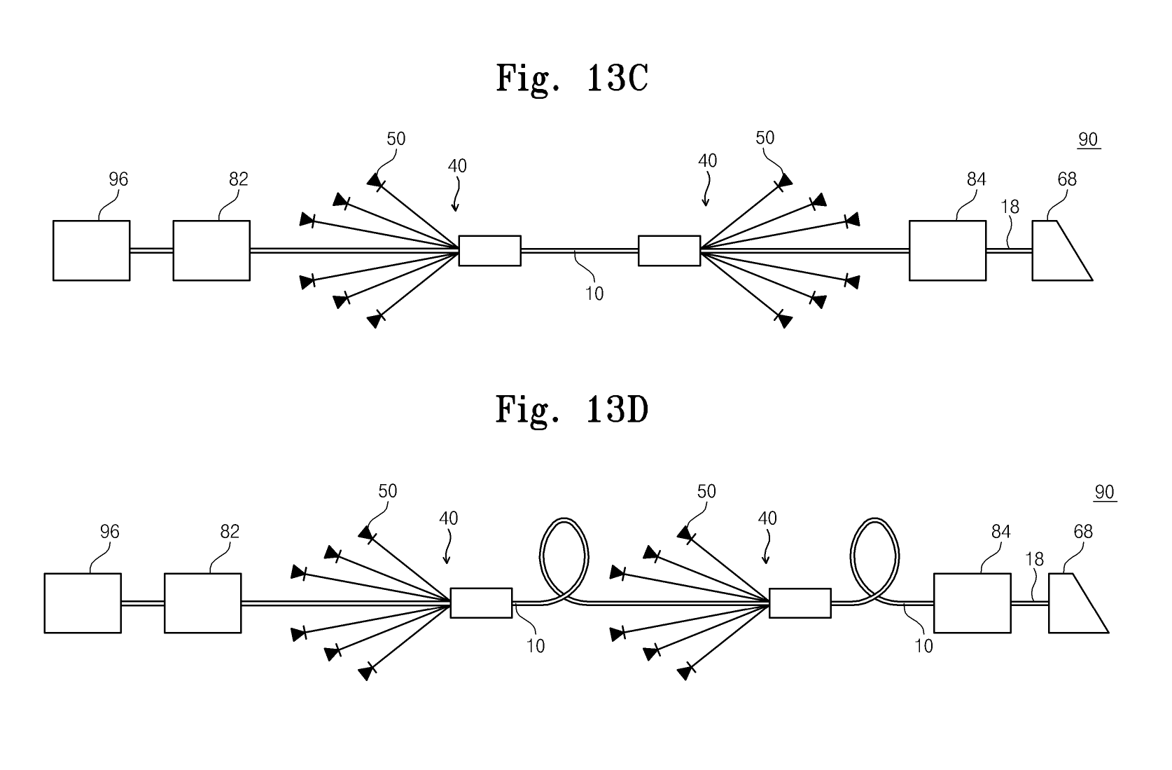

FIGS. 13A through 13D are diagrams illustrating an active optical module 90 according to a fourth embodiment of the present invention.

Referring to FIGS. 13A through 13D, an active optical module 90 according to a fourth embodiment of the present invention may comprise a Master oscillator-Power-Amplifier (MOPA) optical fiber amplifier 90 comprising a master oscillator 96 and a first isolator at one side of the optical fiber coupler 40 shown in FIGS. 8 and 9, and a second isolator 84 at the other side of the optical fiber coupler 40. The MOPA optical fiber amplifier 90 may enhance laser light using pump light 52 delivered from the optical fiber coupler 40. The pump light source 50 may supply the pump light 52 to the first optical fiber 10 through the optical fiber coupler 40. The output laser may be outputted as pulse laser light according to a pulse signal inputted from the master oscillator 96. The master oscillator 96 may include a electrical pulse generator generating the pulsed signal laser.

The first and second isolators 82 and 84 may deliver laser light to an end cap 68 along the first optical fiber 10. The first isolator 82 may pass a signal outputted from the signal source 96. On the other hand, the first isolator 82 may block any light returning to the signal source 96. The second isolator 84 may pass laser light traveling to an end cap 68 through a pigtail optical fiber 18. On the other hand, the second isolator 84 may block any light returning to the first optical fiber 10 through the pigtail optical fiber 18. The second isolator 84 may be omitted.

Referring to FIG. 13A, the active optical module 90 according to the fourth embodiment of the present invention may have a forward pumping mode in which the optical fiber module 40 is disposed in a direction from the first isolator 82 to the second isolator 84. Pulse laser light may be outputted from the second isolator 84 to the end cap 68 through the pigtail optical fiber 18. The optical fiber coupler 40 may be connected to the first optical fiber 10 approaching the first isolator 82. Pump light 52 may be sufficiently absorbed while traveling along the first optical fiber 10 extending from the first isolator 82 to the second isolator 84. Accordingly, in the forward pumping mode, the traveling direction of the pump light 52 in the first optical fiber 10 may be identical to the output direction of the pulse laser light that has been amplified.

Referring to FIG. 13B, the active optical module 90 according to the fourth embodiment of the present invention may have a backward pumping mode in which the optical fiber coupler 40 is disposed in a direction from the second isolator 84 to the first isolator 82. The optical fiber coupler 40 may be coupled to the first optical fiber 10 approaching the second isolator 84. The pump light 52 may be sufficiently absorbed while traveling along the first optical fiber 10 extending from the second isolator 84 to the first isolator 82. Accordingly, in the backward pumping mode, the traveling direction of the pump light 52 in the first optical fiber 10 may be opposite to the output direction of the output laser light that has been amplified.

Referring to FIG. 13C, the active optical module 90 according to the fourth embodiment of the present invention may have a bidirectional pumping mode in which a plurality of optical fiber couplers 40 are disposed opposite to each other in the first optical fiber 10 approaching the first isolator 82 and the second isolator 84, respectively. The plurality of optical fiber couplers 40 may deliver the pump light 52 in opposite directions to each other in the first optical fiber 10 between the first isolator 82 and the second isolator 84. The plurality of optical fiber couplers 40 may be disposed in the forward direction in the first optical fiber 10 adjacent to the first isolator 82, and may be disposed in the backward direction in the optical fiber 10 adjacent to the second isolator 84. Accordingly, in the bidirectional pumping mode, pulse laser may be amplified by the pump light 52 delivered in opposite directions to each other in the optical fiber 10 between the first isolator 82 and the second isolator 84.

Referring to FIG. 13D, the active optical module 90 according to the fourth embodiment of the present invention may have a multi forward pumping mode in which a plurality of optical fiber couplers 40 are disposed in the same direction in the first optical fiber 10 between the first isolator 82 and the second isolator 84. The plurality of optical fiber couplers 40 may deliver the pump light 52 from the first isolator 82 to the second isolator 84. The plurality of optical fiber couplers 40 may be disposed between the first isolator 82 and the second isolator 84. When the pump light supplied from the first optical fiber coupler 40 is depleted in the first optical fiber 10, pump light may be supplied from the second optical fiber coupler 40 to progressively increase the amplification of the laser light. The intensity of the pumping light supplied through the second optical fiber coupler 40 may be greater than that of the pumping light supplied from the first optical fiber coupler 40.

As described above, a tapering region may be formed by conically etching second optical fibers coupled to a first cladding of a first optical fiber. A core of the first optical fiber may be extended in a continuous size without a cutting surface within the tapering region of the second optical fibers. Accordingly, an optical fiber coupler can prevent optical loss caused by coupling mismatch between typical cores having different diameters.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An optical fiber coupler comprising:
a first core;
a first optical fiber comprising a first cladding surrounding a first core; and
a plurality of second optical fibers having a tapering region of a cylindrical shape and surrounding the first cladding of the first optical fiber,
wherein the first core has the same diameter within the tapering region.

2. The optical fiber coupler of claim 1, wherein the first optical fiber further comprises a second cladding surrounding the first cladding.

3. The optical fiber coupler of claim 1, wherein the second optical fibers comprise a multi mode fiber.

4. A method of fabricating an optical fiber coupler, comprising:
fixing at least one of second optical fibers around a first optical fiber;
fusing the second optical fibers to the first optical fiber; and
etching the second optical fibers in a taper shape.

5. The method of claim 4, further comprising coating the first optical fiber exposed to the second optical fibers with a protection layer prior to the etching of the second optical fibers.

6. The method of claim 5, wherein the etching of the second optical fibers comprises at least one of a wet etching and a laser etching.

7. The method of claim 6, wherein the wet etching comprises etching the second optical fibers using at least one of buffered etching solution and fluoric acid.

8. The method of claim 7, wherein the buffered etching solution comprises ammonium fluoride and fluoric acid.

9. The method of claim 5, wherein the second optical fibers are etched by a laser.

10. The method of claim 4, further comprising performing a surface treatment after the etching of the second optical fibers.

11. The method of claim 10, wherein the surface treatment comprises melting surface flaws on the second fibers using a torch or a laser.

12. The method of claim 4, further comprising packaging the first optical fiber and the second optical fibers.

13. An active optical module comprising:
a pump light source;
an optical fiber coupler comprising a first optical fiber comprising a first core and a first cladding surrounding the first core, and a plurality of second optical fibers having a tapering region of a cylindrical shape and surrounding the first cladding of the first optical fiber;
a first optical device disposed at one end of the first optical fiber; and
a second optical device disposed at the other end of the first optical fiber opposite to the first optical device, the second optical device emitting laser light generated in the first optical fiber,
wherein the first core of the optical fiber coupler has the same diameter within the tapering region.

14. The active optical module of claim 13, wherein the active optical module has a forward pumping mode in which the tapering region of the optical fiber coupler is disposed in a direction from the first optical device to the second optical device.

15. The active optical module of claim 13, wherein the active optical module has a backward pumping mode in which the tapering region of the optical fiber coupler is disposed in a direction from the second optical device to the first optical device.

16. The active optical module of claim 13, wherein the active optical module has a bidirectional pumping mode in which the tapering regions of a plurality of optical fiber couplers are disposed in opposite directions to each other.

17. The active optical module of claim 13, wherein the active optical module has a multi forward pumping mode in which the tapering regions of a plurality of optical fiber couplers are disposed in a direction from the first optical device to the second optical device.

18. The active optical module of claim 13, wherein the first optical device and the second optical device comprise a first mirror and a second mirror, respectively.

19. The active optical module of claim 18, further comprising a modulator disposed in the first optical fiber between the first mirror and the second mirror.

20. The active optical module of claim 13, wherein the first optical device and the second optical device comprise a first isolator and a second isolator, respectively.
